(19) United States
(12) Patent Application Publication
(10) Pub. No.: US 2023/0311716 A1
(43) Pub. Date: Oct. 5, 2023

(54) INNENRAUMVERSTELLSYSTEM FÜR EIN FAHRZEUG

(71) Applicant: Brose Fahrzeugteile SE & Co. Kommanditgesellschaft, Bamberg, Bamberg (DE)

(72) Inventor: Christian HERRMANN, Grossheirath (DE)

(21) Appl. No.: 18/044,067

(22) PCT Filed: Sep. 1, 2021
(86) PCT No.: PCT/EP2021/074135

§ 371 Date: Jul. 25, 2023

(30) Foreign Application Priority Data
Sep. 8, 2020 (DE) 10 2020 211 258.4

(51) Int. Cl. B60N 2/02; B60N 2/16; B60N 2/06

(52) U.S. Cl. CPC B60N 2/0232; B60N 2/16; B60N 2/06; B60N 2002/0272

(57) ABSTRACT

It is provided an interior adjustment system for a vehicle, comprising a first interior assembly which has a first adjustment device for adjusting the first interior assembly, at least one second interior assembly which has a second adjustment device for adjusting the at least one second interior assembly and a controller. The controller is designed to activate the second adjustment device in order to adjust the at least one second interior assembly as a function of an adjustment movement of the first interior assembly.

### CROSS-REFERENCE TO A RELATED APPLICATIONS

The present application is a U.S. National Phase of International Application No. PCT/EP2021/074135 entitled “INTERIOR ADJUSTMENT SYSTEM FOR A VEHICLE,” and filed on Sep. 1, 2021. International Application No. PCT/EP2021/074135 claims priority to German Patent Application No. 10 2020 211 258.4 filed on Sep. 8, 2020. The entire contents of each of the above-listed applications are hereby incorporated by reference for all purposes.

### BACKGROUND

The proposed solution relates to an interior adjustment system for a vehicle, as well as a method for adjusting interior assemblies in an interior of a vehicle.

Such an interior adjustment system comprises a first interior assembly which has a first adjustment device for adjusting the first interior assembly, and at least one second interior assembly which has a second adjustment device for adjusting the at least one second interior assembly. A controller serves for controlling adjustment processes of the first interior assembly and/or the second interior assembly.

The first interior assembly can be, for example, a vehicle seat which can be adjusted in the interior of a vehicle. Such a vehicle seat can be adjustable, for example, in terms of its longitudinal position, in terms of its rotational position, in terms of the inclination of a backrest and/or in terms of the seat height, wherein an adjustment can generally be possible for setting a comfort position for a vehicle occupant but also for setting a predetermined functional position, for example a flat position for increasing a loading space, as required.

In future interior concepts, in particular in the context of autonomously driven vehicles, there may be the possibility of adjusting interior assemblies to a greater extent, in particular over longer adjustment paths. For example, in the future, there may be the possibility of moving a vehicle seat over a relatively long distance between a front and a rear position in the vehicle interior as required, wherein additionally the rotational position of the vehicle seat may also be adaptable as required.

In such interior concepts it is generally desirable to enable the user to set interior assemblies in a simple, convenient and intuitive manner

A vehicle seat in the interior of a vehicle which is electrically adjustable is disclosed in US 2017/0166089 A1. The adjustment of the vehicle seat can be initiated by a user using a gesture control system, for example by a user performing a predetermined gesture in the region of the vehicle seat, and for example being able to bring about thereby a pivoting of a backrest or a longitudinal adjustment of the vehicle seat in the vehicle interior.

An interior adjustment system is disclosed in DE 11 2015 000 921 T5, in which vehicle seats can be adjusted, for example, in a cargo loading mode for increasing a loading surface of a vehicle. In cargo loading mode, for example, pressure can be exerted by an object on a backrest of a vehicle seat, whereupon the backrest is adjusted. If further space is required, further seats can also be adjusted.

### SUMMARY

It is an object underlying the proposed solution to provide an interior adjustment system for a vehicle as well as a method for adjusting interior assemblies in an interior of a vehicle, which make an adjustment of interior assemblies simple, convenient and intuitive for a user.

This object is achieved by an interior adjustment system having features as described herein.

Accordingly, the controller is designed to activate the second adjustment device in order to adjust the at least one second interior assembly as a function of an adjustment movement of the first interior assembly.

Various interior assemblies which are adjustable via different adjustment devices are provided in the interior adjustment system. The interior assemblies can be spatially separate from one another and structurally independent of one another, wherein an adjustment movement of the interior assemblies takes place in a controlled manner, however, such that an adjustment movement on one interior assembly brings about a re-adjustment movement on a further interior assembly as required. For example, in the case of a user-initiated adjustment of an interior assembly, this makes it possible to re-adjust a further interior assembly such that a function made available by this further interior assembly can also be provided.

The first interior assembly can be, for example, a vehicle seat or an assembly of a vehicle seat. The first adjustment device can provide, for example, a seat longitudinal adjustment device, a seat height adjustment device, a backrest inclination adjustment device, a head restraint adjustment device, a seat depth adjustment device or a further adjustment device for adjusting the vehicle seat as a whole or an assembly of the vehicle seat. The first adjustment device can be designed with an electric motor and thus permit an adjustment of the assigned assembly by electric motor. The first adjustment device can also be operated manually, however, for example in order to move the vehicle seat or an assembly of the vehicle seat manually, for example for adjusting the longitudinal position of the vehicle seat or for setting a backrest inclination.

The second interior assembly can accordingly be a further interior assembly which is separate from the first interior assembly, for example in the form of a console element, an armrest, a holding device for holding a functional assembly, a ventilation device, a sound generating device, a light generating device, a display, an operating element or a storage device. For example, via the second interior assembly a function can be provided in the region of the first interior assembly, which is designed for example as a vehicle seat, for example as a storage space or as a holding device. As the controller is designed to activate the second adjustment device in order to adjust the second interior assembly as a function of an adjustment movement of the first interior assembly, the second interior assembly can be re-adjusted with an adjustment movement on the first interior assembly, so that as a function of the newly set position of the first interior assembly the second interior assembly can be brought into such a position that a function provided by the second interior assembly can also be made available, for example in order to permit a user on a vehicle seat convenient access to the second interior assembly, for example in the form of a console element or in the form of a storage device such as a table or the like.

A console element can be arranged, for example, adjacent to the vehicle seat and can be adjustable relative to the vehicle seat. Such a console element can provide a storage space, for example, wherein further functional assemblies, for example a holding device in the form of a cell phone holder or an operating assembly or the like, can be arranged on the console element.

An armrest can be arranged, for example, on a console element but can also be configured and adjustable separately from a console element.

A holding device for holding a functional assembly, for example a cell phone, can be attached to a console element and can be adjustable on the console element, but can also be fastened at a different location in a vehicle. The holding device can provide a mechanical holding function and additionally, for example, an electrical function, for example for charging a cell phone.

Generally storage devices such as storage compartments, tables or the like, can be re-adjusted and adapted by an assigned adjustment device as a function of an adjustment movement of the first interior assembly, for example in the form of a vehicle seat.

A ventilation device can be configured, for example, by a nozzle or a fan. By re-adjusting the ventilation device an airflow can be changed, for example, in terms of its direction as a function of an adapted position of the first interior assembly, for example in the form of a vehicle seat, such that the airflow continues to be directed toward the first interior assembly, for example the vehicle seat, as a function of a changed seating position of a user, for example.

By re-adjusting a ventilation device, in particular, an air-conditioning zone can be re-adjusted in a vehicle interior, so that individually air-conditioned regions in a vehicle interior can be set and adapted as required as a function of the position of the first interior assembly, for example in the form of a vehicle seat.

A sound generating device can be implemented, for example, by one or more loudspeakers of a sound system of the vehicle. By re-adjusting the sound generating device a sound field can be oriented toward the first interior assembly, for example in the form of a vehicle seat, such that a desired acoustic is provided and re-adjusted in the region of the first interior assembly.

The light generating device can be, for example, illumination inside a vehicle, for example a reading lamp or the like, or even a projection device for signaling, for example, traffic information or a device for generating light effects. By re-adjusting the light generating device as a function of an adjustment movement of the first interior assembly, for example in the form of a vehicle seat, an illumination area can be adapted, for example, as a function of the seating position of a vehicle occupant or a projection of information can be re-adjusted such that the projection continues to be within the field of view of the user.

The second interior assembly can also be, for example, a display, for example in the form of a screen of a navigation device or an entertainment system of the vehicle, which is re-adjusted as a function of an adjustment movement of the first interior assembly, for example in the form of a vehicle seat, so that the display can continue to be seen, for example, comfortably by a user.

An operating element can serve, for example, for operating a functional assembly, for example an entertainment system, an on-board computer, a navigation device, a window lifter, a vehicle seat, an adjustment assembly such as a vehicle door or an exterior mirror. The operating element can implement a second interior assembly which can be changed in terms of its position by an assigned second adjustment device, so that the interior assembly can be re-adjusted as a function of an adjustment movement of the first interior assembly, for example in the form of a vehicle seat, and adapted in terms of its position, so that a vehicle occupant can continue to access, for example, the operating element in a convenient manner.

Further interior assemblies can be adjustable and re-adjustable as a function of an adjustment movement of a first interior assembly, for example in the form of a vehicle seat. Such interior assemblies can also be, for example, a seat belt height setting, a seat belt feeder, a steering wheel or, for example, a heating assembly, for example in the form of an infrared heater which additionally or alternatively to the aforementioned interior assemblies can be adjustable as a function of the adjustment movement of the first interior assembly, for example in the form of a vehicle seat.

The aforementioned different second interior assemblies can in each case be adjustable separately or in combination as a function of the adjustment movement of the first interior assembly, for example in the form of a vehicle seat. Thus it is conceivable that an individual assembly of the aforementioned interior assemblies is adjustable as a function of the adjustment movement of the first interior assembly. It is, however, also conceivable that a plurality or all of the aforementioned second interior assemblies can be set as a function of the adjustment movement of the first interior assembly, so that when the first interior assembly is adjusted a plurality of second interior assemblies can be re-adjusted together as a function of a newly set position of the first interior assembly.

In one embodiment, the first adjustment device has an electric motor for adjusting the first interior assembly by electric motor. The adjustment of the first interior assembly can thus be carried out by electric motor, for example by a user actuating the first adjustment device via an operating element, for example in the form of a button or switch, and thus moving the first interior assembly out of a recently adopted position into a new adjusted position.

However, an adjustment of the first interior assembly can also be possible manually, for example, by a user displacing, rotating or pivoting the first interior assembly.

The adjustment of the first interior assembly can be initiated by actuating an operating element, for example in the form of a button or switch. However, a gesture control system is also conceivable, for example, by recognizing a user gesture by means of a gesture recognition device, for example in the form of an interior monitoring system. Via such a user gesture, for example in the form of a hand movement for example (as is described for example in US 2017/166089A), an adjustment process of a vehicle seat can be initiated, for example for pushing forward the vehicle seat or for pivoting a backrest, wherein the user gesture is evaluated by the controller and the controller activates the first adjustment device assigned to the first interior assembly for adjusting the first interior assembly.

In one embodiment, the second adjustment device has an electric motor for adjusting the second interior assembly by electric motor. The adjustment of the second interior assembly is carried out by electric motor in a controlled manner as a function of the adjustment movement of the first interior assembly. If an adjustment movement of the first interior assembly is detected, the second interior assembly, which is controlled by the controller, is re-adjusted by using the second adjustment device, so that the second interior assembly is moved into a position as a function of the newly set position of the first interior assembly which has now been adopted.

Generally, the first interior assembly can be moved by actuating the first adjustment device (by electric motor or manually) from a current first position into an adjusted second position. The controller is designed to activate the second adjustment device in order to adjust the at least one second interior assembly from a current first functional position into an adjusted second functional position as a function of the second position of the first interior assembly. If the first interior assembly is moved from a current first position into an adjusted second position, the second interior assembly is correspondingly re-adjusted, wherein the new position of the second interior assembly depends on the adjusted position of the first interior assembly and the second interior assembly can thus be moved into a position relative to the adjusted first interior assembly such that, for example, a function provided by the second interior assembly can also be made available. For example, in this manner a second interior assembly in the form of a console element of the first interior assembly, for example in the form of a vehicle seat, can be re-adjusted, so that a user on the vehicle seat can continue to access the console element or an assembly arranged thereon, such as a cell phone holder, an armrest or an operating element.

The second interior assembly can be re-adjusted synchronously with the adjustment of the first interior assembly, so that when the first interior assembly is adjusted the second interior assembly is already moved therewith in a controlled manner

Alternatively, the second interior assembly can be adjusted with a time delay, for example only when the adjustment movement of the first interior assembly is already completed. In turn, however, the second interior assembly is moved into a position which depends on the newly set position of the first interior assembly, so that the second interior assembly tracks the first interior assembly in a controlled manner

The second interior assembly can be re-adjusted, for example, in an automated manner without user intervention. It is also conceivable, however, that before the second interior assembly is re-adjusted, a user input is anticipated on an assigned operating element for confirming the adjusting process, and a re-adjustment takes place only after the user confirmation.

In one embodiment, the controller is designed to monitor an adjustment criterion and to activate the second adjustment device in order to adjust the at least one second interior assembly from the current first functional position into the adjusted second functional position as a function of the monitoring of the adjustment criterion. The adjustment of the second interior assembly does not always take place, or not always in the same form, but takes place as a function of an additional adjustment criterion which is monitored as an additional condition for adjusting the second interior assembly. An adjustment of the second interior assembly can be entirely prevented, or adapted, as a function of the monitoring of the adjustment criterion, so that the adjustment movement of the second interior assembly can be performed in various ways as a function of the adjustment criterion.

For example, the controller can be designed to evaluate as an adjustment criterion an operating event, a use state of the at least one second interior assembly, a collision state of the at least one second interior assembly, a driving state of the vehicle or an occupancy state of one or more vehicle seats.

An operating event can be, for example, a setting implemented by a user via an input device such as a button or the like. A user can, for example, expressly select or expressly deselect a re-adjustment of the second interior assembly via such an input device, wherein the setting of the user can refer to all of the second interior assemblies or selected second interior assemblies. An adjustment of the second interior assembly thus takes place as a function of an input made by a user.

With an adjustment movement of the first interior assembly the user can be individually prompted to confirm a re-adjustment of the second interior assembly. Alternatively, a presetting can be defined, for example, by a switch in the vehicle being set to ON or OFF, wherein the second interior assembly is re-adjusted as a function of the presetting.

A use state of the at least one second interior assembly, for example, can be a use state of a display, a beverage holder or a ventilation system. If the second interior assembly is implemented by a display, for example, a re-adjustment takes place, for example only when the display is in use (i.e. is switched on). If the second interior assembly is implemented by a beverage holder, the beverage holder is adjusted, for example, only when the beverage holder is occupied, i.e. an object is arranged on the beverage holder. If the second interior assembly is implemented by a ventilation device, the ventilation system is re-adjusted, for example, only when the ventilation device is in use.

A collision state can be, for example, a risk of collision of the second interior assembly detected by a collision monitoring device, for example an interior monitoring device. If it is established, on the basis of a detection by the collision detection device, that there is sufficient probability that a movement of the second interior assembly poses a risk of collision, an adjustment of the second interior assembly, for example, can be prevented or modified.

For monitoring the driving state of the vehicle it can be monitored whether the vehicle is moving or at a standstill. If the vehicle is at a standstill, for example, the second interior assembly can be re-adjusted to a lesser extent in order to reduce energy consumption. If the vehicle is at a standstill, a re-adjustment is carried out only with a delay or even as a function of an on-board supply voltage, as required. Additionally, a speed of the vehicle can be evaluated, so that for example at a speed above a predetermined threshold a re-adjustment can be entirely prevented.

For monitoring an occupancy state of one or more vehicle seats, it can be monitored whether a vehicle occupant is seated on a specific seat, for example on the driver's seat, and whether further seats are occupied at the same time. For example, if only the driver's seat is occupied, a complete re-adjustment of the interior assemblies relating to the driver's seat, for example a ventilation device, takes place. If the driver's seat and also the front passenger seat are occupied, for example, only individual assemblies are re-adjusted, for example by only individual fan elements being re-adjusted in a ventilation device, but not other elements. Additionally, for example, an adjustment of a central console can be made dependent on whether only the driver's seat is occupied or the driver's seat and the front passenger seat are occupied. For example, it can be provided to re-adjust the central console only when the driver's seat is occupied but not when the front passenger seat is occupied. Moreover, as required, the adjustment of the second interior assembly can be made dependent on whether a user comfort of a different occupant is potentially impaired by the adjustment of the second interior assembly. Thus if this rear seat row were to be occupied by one or more vehicle occupants, an adjustment of a central console, for example, can be prevented or only carried out to a limited extent if the central console of a rear seat row were to be approached due to the adjustment, and thus the comfort of the vehicle occupants were to be impaired.

Such adjustment criteria can be evaluated individually or in combination.

Further adjustment criteria can also be evaluated as required. If, for example, a re-adjustment of the at least one second interior assembly is not expedient, since in the adjusted position of the first interior assembly a use of the second interior assembly is not possible in a meaningful manner, a re-adjustment of the second interior assembly can be prevented as required. If, for example, a vehicle seat implementing a first interior assembly is adjusted such that a display implementing a second interior assembly can no longer be meaningfully used in the adjusted position of the vehicle seat, a re-adjustment of the display can be prevented. This can be predetermined in advance by configuration.

In one embodiment, the controller is designed to determine the second functional position as a function of the adjustment criterion. Thus the second functional position, in which the second interior assembly is re-adjusted, can be established differently as a function of the monitoring of the adjustment criterion. For example, a second interior assembly, which is implemented by a central console, a ventilation system or a display, can be adjusted in different ways as a function of an occupancy state of one or more vehicle seats.

The first interior assembly, for example, is adjustable along a first movement path in a vehicle interior. The first interior assembly thus can be moved, for example, along a defined, predetermined movement path in the vehicle interior, for example in order to adjust a vehicle seat along a vehicle floor and thus, for example, to adapt a longitudinal position of the vehicle seat. In principle, the first interior assembly can be moved into any different individually settable positions along the first movement path, so that the first interior assembly can be adjusted in a variable manner in the vehicle interior. The adjustment movement of the second interior assembly is controlled as a function of the newly set position of the first interior assembly which, for example, is detected by sensor via a position detection system in the first adjustment device or a different sensor device, for example in the form of an interior monitoring system.

Such a movement path can, for example, be predetermined by guide rails or the like.

Additionally, the at least one second interior assembly can also be adjustable along a second movement path in the vehicle interior, so that the second interior assembly is also movable along a defined movement path in the vehicle interior. In principle, the second interior assembly can adopt any positions along the second movement path, wherein the adjustment of the second interior assembly is carried out as a function of an adjustment movement of the first interior assembly and the position of the second interior assembly is set as a function of the new adjusted position of the first interior assembly.

In one embodiment, the interior adjustment system has a sensor device for detecting a position of the first interior assembly and/or the at least one second interior assembly. Such a sensor device can be configured, for example, by an interior monitoring system, for example in the form of a radar system, a lidar system or an ultrasound system, and permit a detection of objects in the vehicle interior. However, such a sensor device can also be implemented, for example, by a position detection system on the individual adjustment devices, for example via position sensors on the interior assemblies or by detecting an absolute or relative position of an adjustment device, for example by using Hall sensors. The second interior assembly is accordingly controlled using the known newly set position of the first interior assembly, so that with an adjustment movement on the first interior assembly the second interior assembly is re-adjusted in such a manner that a function provided by the second interior assembly can continue to be made available for a vehicle occupant in a convenient manner.

The controller can be, for example, a central electronic controller of a vehicle, which serves for central evaluation and processing of signals and undertakes the central control functions in the vehicle.

It is also conceivable, however, that the controller is implemented by a plurality of individual decentralized controllers—for example controllers which are assigned to the individual adjustment devices.

According to a further aspect, a method for adjusting interior assemblies in an interior of a vehicle comprises the following steps: adjusting a first interior assembly by using a first adjustment device; adjusting at least one second interior assembly by using a second adjustment device; and at the same time controlling the second adjustment device in order to adjust the at least one second interior assembly as a function of an adjustment movement of the first interior assembly.

The advantages and advantageous embodiments described above for the interior adjustment system also apply equally to the method, so that reference is to be made extensively to the above embodiments.

### BRIEF DESCRIPTION OF THE DRAWINGS

The idea underlying the proposed solution is to be explained in more detail hereinafter with reference to the exemplary embodiments shown in the figures.

FIG. 1 shows a schematic view of a vehicle interior, with interior assemblies arranged therein.

FIG. 2 shows a further schematic view of a vehicle interior.

FIG. 3 shows a schematic view of a first interior assembly together with assigned second interior assemblies and a controller.

FIG. 4 shows a schematic view of an adjustment movement of a first interior assembly, for example in the form of a vehicle seat, and a re-adjustment movement of an assigned second interior assembly, for example a console element.

FIG. 5 shows a schematic view of a vehicle interior, with adjustable interior assemblies according to a further exemplary embodiment.

### DETAILED DESCRIPTION

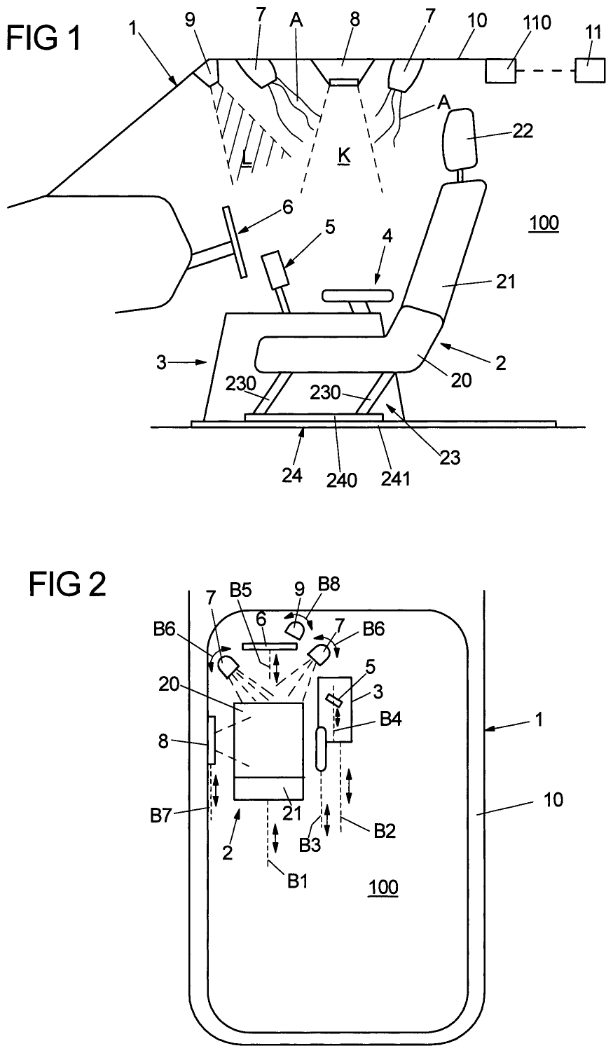

FIGS. 1 and 2 show in schematic views a vehicle 1 which has a vehicle body 10 and an interior 100 defined by the vehicle body 10. Interior assemblies 2-9 which serve for providing and performing different functions in the vehicle interior 100 are arranged in the interior 100.

Thus an interior assembly in the form of a vehicle seat 2 is arranged in the interior 100, the vehicle seat being configured by a seat part 20 and a backrest part 21 which is adjustably arranged thereon, as well as a head restraint 22 which is arranged at the upper end of the backrest part 21. The vehicle seat 2 has a height adjustment device 23 via which the vehicle seat 2 is coupled to a floor assembly in the form of a longitudinal adjustment device 24. The height adjustment device 23 has pivoting elements 230 which can be pivoted in order to adjust the height of the seat part 20 in this manner The longitudinal adjustment device 24 has guide rails 240, 241, an upper guide rail 240 thereof being connected to the pivoting elements 230 and thus bearing the vehicle seat 2, while a lower guide rail 241 is connected to a vehicle floor. The upper guide rail 240 is longitudinally adjustable relative to the lower guide rail 241, so that the longitudinal position of the vehicle seat 2 can be set by moving the guide rails 240, 241 relative to one another.

A further interior assembly is implemented by a console element 3 which is arranged, for example, in the vehicle transverse direction adjacent to the vehicle seat 2 and, for example, bears an armrest 4 and a holding device 5, for example in the form of a cell phone holder. Further functional assemblies, such as for example an operating element, can be arranged on the console element.

A steering wheel 6 for steering the vehicle 1 is arranged in the known manner in the region of a dashboard of the vehicle 1.

Ventilation devices 7 in the form of nozzles, for example, serve for providing an airflow A and thus for ventilation and for setting an air-conditioning zone in the region of the vehicle seat 2 as required.

A sound generating device 8 in the form of one or more loud speakers serves for generating a sound field K in the region of the vehicle seat 2.

A light generating device 9 serves, for example, for illumination or for generating a light effect, and to this end generates an illumination area L.

Further interior assemblies, for example in the form of operating elements, a seat belt height adjuster, a seat belt feeder, a display or the like, can be present and adjustable in the interior 100 of the vehicle 1.

As is illustrated schematically in FIG. 2, the interior assemblies 2-9 in each case can be adjustable in the interior 100 along assigned movement paths B1-B8.

The vehicle seat 2 can be longitudinally adjustable along an assigned movement path B1 which is predetermined, for example, by the guide rails 240, 241 of the longitudinal adjustment device 24, wherein additionally sub-assemblies of the vehicle seat 2, in particular the seat part 20, the backrest part 21 and the head restraint 22, can be adjustable via respectively assigned adjustment devices.

The console element 3 can be longitudinally adjustable, for example, along a movement path B2 in the interior 100, wherein the movement path B2 can be predetermined, for example, via guide rails, via which the console element 3 is arranged on the vehicle floor.

The armrest 4 is arranged, for example, on the console element 3 and can be adjustable along a movement path B3 relative to the console element 3.

The holding device 5 is also arranged on the console element 3 and can be longitudinally adjustable, for example, along a movement path B4 on the console element 3.

The steering wheel 6 can be adjustable along a movement path B5 between different positions and thus be moved toward the vehicle seat 2 or moved away from the vehicle seat 2. Additionally, a height setting of the steering wheel 6 can also be possible.

Nozzles of the ventilation device 7 can be pivotable, for example, wherein such nozzles can be arranged, for example, in the region of the roof lining or even in the region of pillars, for example the A-pillar, B-pillar or C-pillar of the vehicle body 10. A respectively assigned movement path B6 in this case is predetermined by the pivoting path of the nozzles.

The sound generating device 8, for example, can be longitudinally adjustable and/or pivotable along the movement path B7. A loudspeaker implementing the sound generating device 8 can be arranged, for example, in the region of the roof lining or in the region of a vehicle door.

A light generating device 9 in the form of a reading lamp, for example, can be pivotable along a movement path B8, for example, and to this end can be arranged, for example, in the region of the roof lining of the vehicle.

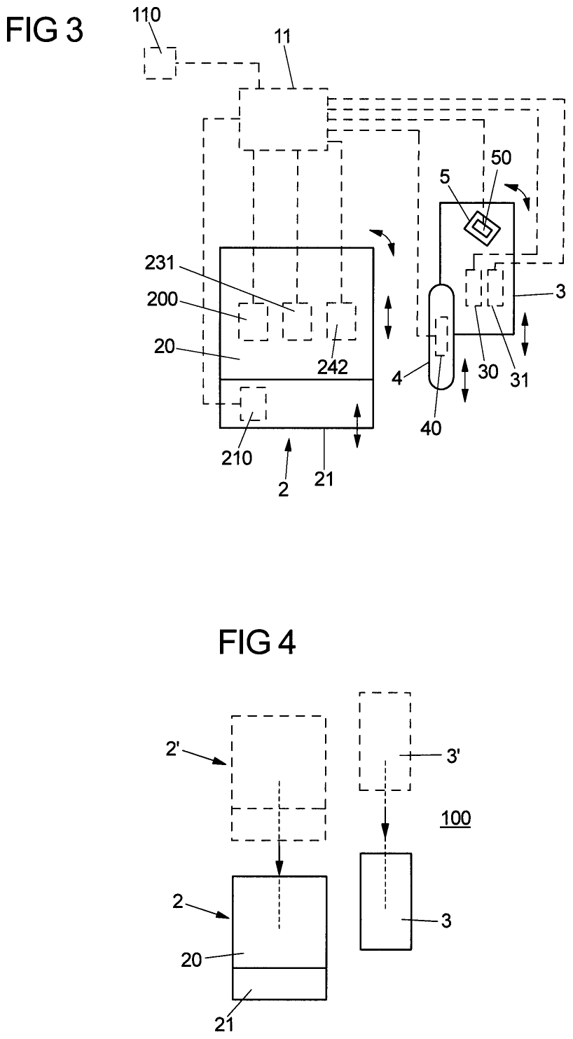

As schematically shown in FIG. 3, the interior assemblies 2-9 can be adjustable by assigned adjustment devices in the interior 100 so that the position and orientation of the interior assemblies 2-9 in the interior 100 can be adapted. FIG. 3 illustrates this by way of a sub-assembly of the interior assemblies 2-9, wherein in principle all interior assemblies 2-9 in the interior 100 of the vehicle 1 can be adjustable via one respectively assigned adjustment device.

In the example shown in FIG. 3, the vehicle seat 2 has adjustment devices 200, 210, 231, 242 which can serve for adjusting the vehicle seat 2 as a whole or for adjusting sub-assemblies of the vehicle seat 2. For example, a rotational position of the vehicle seat 2 about a vehicle vertical axis in the vehicle interior can be adapted via an adjustment device 200 assigned to the seat part 20. For example, the inclination position of the backrest part 21 can be adapted via an adjustment device 210 which is assigned to the backrest part 21. The height of the seat part 20 can be set relative to the vehicle floor via an adjustment device 231 which is assigned to the seat height adjuster 23. The longitudinal position of the vehicle seat 2 in the interior 100 can be set via an adjustment device 242 which is assigned to the longitudinal adjustment device 24.

Adjustment devices which serve for adjusting the further interior assemblies 3-9 are also assigned to the further interior assemblies 3-9. In the example according to FIG. 3, the console element 3 is assigned adjustment devices 30, 31, via which the rotational position and the longitudinal position of the console element 3 can be adjusted. The armrest 4 arranged on the console element 3 is assigned an adjustment device 40, via which the armrest 4 can be adjusted along the console element 3. The holding device 5, for example in the form of a cell phone holder, is assigned an adjustment device 50 via which a rotational position and/or a longitudinal position of the holding device 5 on the console element 3 can be adjusted.

The adjustment devices 200, 210, 231, 242, 30, 31, 40, 50 are connected in each case to a controller 11 which serves for controlling the different adjustment devices 200, 210, 231, 242, 30, 31, 40, 50. The controller 11 implements a central controller in the vehicle 1, for example, and can also serve for controlling further functions of the vehicle 1.

The adjustment devices 200, 210, 231, 242, 30, 31, 40, 50 can have in each case an electric motor which permits an adjustment of the respectively assigned interior assembly 2-9 by electric motor. The adjustment devices 200, 210, 231, 242, 30, 31, 40, 50 can also permit a manual adjustment of the respectively assigned interior assembly 2-9 as required.

The adjustment devices 200, 210, 231, 242, 30, 31, 40, 50 can be implemented, for example, by spindle drives, wobble drives, planetary drives or other drives for longitudinally adjusting, pivoting or rotating a respectively assigned interior assembly.

In the context of the new interior concepts, an adjustability of interior assemblies 2-9 can be possible in a variable manner over a relatively large adjustment path in the interior 100 of a vehicle 1. For example, an adjustability of a vehicle seat 2 can be possible such that the vehicle seat 2 can be moved from a front position into a rear position in the interior 100, wherein additionally for example a rotational position of the vehicle seat 2 can be adapted as required, so that the vehicle seat 2, for example, can face other vehicle seats.

For such a flexible and extensive adjustability of interior assemblies 2-9, there is a need to make the adjustment as simple and convenient as possible for a user.

Against this background, it is proposed in the present case to adapt to one another the adjustment movement of structurally separate interior assemblies, which are in principle independent of one another, such that an adjustment movement of a first interior assembly 2 brings about a re-adjustment of one or more other second interior assemblies 3-9. If a first interior assembly 2 is adjusted, one or more further second interior assemblies 3-9 are re-adjusted, so that the second interior assemblies 3-9 are automatically moved into a position as a function of the newly set position of the first interior assembly 2.

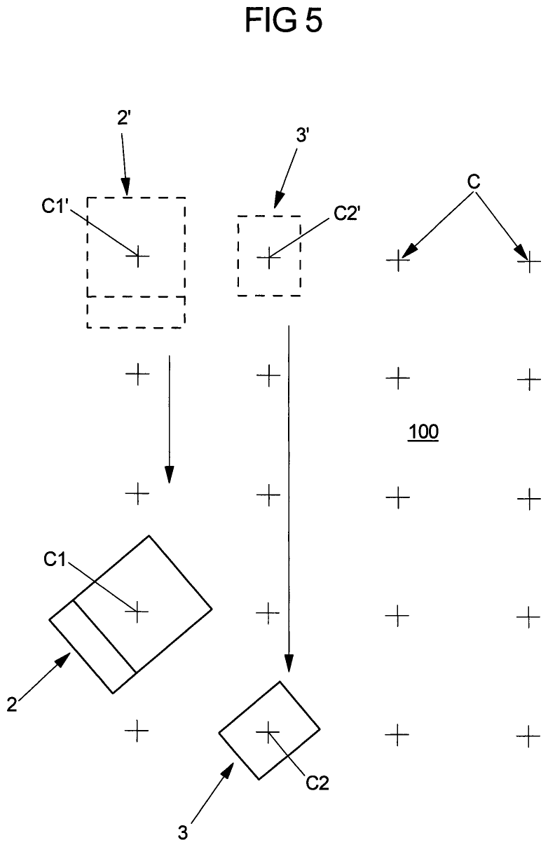

This is illustrated in FIG. 4 by way of the vehicle seat 2 and the console element 3. The first interior assembly in this case is the vehicle seat 2. The re-adjusted second interior assembly is implemented by the console element 3.

If the vehicle seat 2 is adjusted from a previously adopted position, shown in FIG. 4 by way of the vehicle seat 2′ shown in dashed lines, into a new position, for example by the vehicle seat 2 being displaced to the rear longitudinally, the second interior assembly in the form of the console element 3 is then re-adjusted such that the console element 3 is adjusted from a previous position, shown in FIG. 4 by the console element 3′ illustrated in dashed lines, into a newly set position as a function of the adjusted position of the vehicle seat 2. For example, the console element 3 can be moved into a position relative to the vehicle seat 2 such that once again the console element 3 at least approximately adopts the same relative position to the vehicle seat 2 as previously and thus is accessible to a vehicle occupant in the same manner.

In principle, the vehicle seat 2 can be adjustable into any individually settable positions along a defined movement path in the interior 100, as shown in FIG. 4. Such a movement path can be predetermined, for example, by guide rails or by a defined mobility, for example in the form of a pivotability.

The console element 3 (or further interior assemblies 4-9) can also be movable along a defined movement path in the interior 100, wherein in principle the console element 3 can adopt any positions along the assigned movement path, but in the course of a re-adjustment process is moved into a position as a function of the adjusted position of the vehicle seat 2.

As illustrated in FIG. 5, in a further exemplary embodiment, interior assemblies 2-9, for example in the form of a vehicle seat 2 or a console element 3, can be adjustable substantially freely and slidably along a vehicle floor, as described for example in the not pre-published German patent application having the file reference 10 2019 213 012.7. A vehicle seat 2 and a console element 3 can be adjustable, for example, between anchor points C, wherein the vehicle seat 2 and the console element 3, for example, can be moved to any anchor points C in order to be locked to the vehicle floor at a respectively reached anchor point C.

In the exemplary embodiment according to FIG. 5, the console element 3 is also tracked as a function of an adjustment movement of the vehicle seat 2, wherein in the example according to FIG. 5 the vehicle seat 2, for example, is firstly adjusted in terms of its longitudinal position from a previous anchor point C1′ to a new anchor point C1 and additionally rotated, and the console element 3 is correspondingly also adjusted longitudinally from a previous anchor point C2′ to a new anchor point C2 and additionally rotated. The new anchor point C2 and the rotational position of the console element 3 are determined as a function of the adjusted position of the vehicle seat 2 and accordingly the re-adjustment movement of the console element 3 is controlled by the controller 11.

In one embodiment, a sensor device 110 in the form of a interior monitoring system is connected to the controller 11. The positions of the different interior assemblies 2-9 can be detected via the sensor device 110, so that, for example, the position of one or more further interior assemblies 3-9 can be adapted as a function of the position of an interior assembly 2.

A re-adjustment movement of a (second) interior assembly 3-9 can take place as a function of an adjustment movement of a (first) interior assembly 2 synchronously with the adjustment movement of the (first) interior assembly 2. Alternatively, the re-adjustment movement can be undertaken after the adjustment of the (first) interior assembly 2 has taken place, so that the adjustment movement of the (first) interior assembly 2 is first completed and then the further (second) interior assembly 3-9 is re-adjusted as a function of the now adopted position of the (first) interior assembly 2.

A re-adjustment movement of the second interior assembly 3-9 can take place automatically and always when a first interior assembly 2 is adjusted.

Alternatively, however, an adjustment movement of the second interior assembly 3-9 can also depend on an additional adjustment criterion, so that an adjustment movement of the second interior assembly 3-9 does not take place at all or in a modified manner as a function of a monitoring of the adjustment criterion by the controller 11.

Such an adjustment criterion can be, for example, an operating event of a user. For example, by presetting via an input device, for example a switch or button, a user can predetermine that a re-adjustment of the second interior assembly 3-9 is to take place always or not at all.

Additionally or alternatively, as an adjustment criterion it can be evaluated whether the second interior assembly 3-9 is in use or not. If a display is in use, for example, a re-adjustment of the display takes place, for example. If the display is accordingly switched off, the display is optionally not re-adjusted with a movement of a vehicle seat. An occupancy state of a beverage holder or an operating state of a ventilation device can also be monitored in order to carry out a re-adjustment as a function of the occupancy state or the operating state.

Additionally or alternatively, it can also be monitored whether a use of the second interior assembly 3-9 is still expedient at the target position of the first interior assembly 2, so as to bring about a re-adjustment of the second interior assembly 3-9 only when a use is identified as expedient at the target position of the first interior assembly 2. For example, a display is not re-adjusted when a vehicle seat is moved from an upright position into a reclined position, since in this case it can be assumed that the display is no longer intended to be used in the reclined position of the vehicle seat. If a vehicle seat is rotated by 180° from a position facing forward into a position facing backward, a ventilation device in the region of the dashboard at the front in the vehicle is optionally not re-adjusted.

Additionally or alternatively, the re-adjustment of the second interior assembly 3-9 can also be made dependent on a collision detection. If it is detected by a collision detection device, for example implemented by an interior monitoring system, that an obstacle is present in the movement path of the second interior assembly 3-9, an adjustment of the second interior assembly 3-9 can be prevented as required.

Additionally or alternatively, the re-adjustment of the second interior assembly 3-9 can also be made dependent on a vehicle operating state. For example, when the vehicle is at a standstill, the re-adjustment of the second interior assembly 3-9 can be undertaken differently from when the vehicle is traveling. Additionally, for example, the re-adjustment can be made dependent on a driving speed, by a re-adjustment being carried out to a different extent at lower speeds than at high driving speeds, for example.

Additionally or alternatively, an occupancy state of one or more vehicle seats can also be monitored as an adjustment criterion. If only the driver's seat is occupied, for example, second interior assemblies 3-9 which relate to the driver's seat can be adjusted as a function of the adjustment of the driver's seat (which in this case implements a first interior assembly). If additionally the front passenger seat is occupied, however, the re-adjustment of the second interior assembly 3-9 can be modified so as not to adjust individual second interior assemblies, for example fan elements or a display, or to adjust these individual second interior assemblies to a different extent. Additionally, a re-adjustment of a second interior assembly, for example a central console, can be modified if it is established that a rear seat row is occupied by one or more vehicle occupants, in order to prevent the comfort of the vehicle occupants on the rear seat row from being impaired by the adjustment of the central console.

The idea underlying the solution is not limited to the above-described exemplary embodiments but can also be implemented in different ways.

In principle, very different interior assemblies can be adjustable in a vehicle interior, wherein the adjustment movement of one or more interior assemblies can depend on an adjusting process on a further interior assembly. Thus a first interior assembly can be implemented, for example, by a vehicle seat, the adjustment movement thereof bringing about a re-adjustment of other interior assemblies. However, such a first interior assembly can also be implemented by a different functional unit, other interior assemblies being re-adjusted as a function thereof.

In principle, the first interior assembly can be individually adjusted by a user and thus is not limited to an adjustment movement between defined end points. The second interior assembly is re-adjusted as a function of an individually set position of the first interior assembly, such that the newly set position of the second interior assembly depends on the position of the first interior assembly.

### List of Reference Signs

1 Motor vehicle
10 Vehicle body
100 Interior
11 Controller
110 Sensor device
2, 2′ Interior assembly (vehicle seat)
20 Seat part
200 Adjustment device
21 Backrest part
210 Adjustment device
22 Head restraint
23 Height adjustment device
230 Pivoting element
231 Adjustment device
24 Longitudinal adjustment device
240, 241 Guide rail
242 Adjustment device
3, 3′ Interior assembly (console element)
30, 31 Adjustment device
4 Interior assembly (armrest)
40 Adjustment device
5 Interior assembly (holding device)
50 Adjustment device
6 Interior assembly (steering wheel)
7 Interior assembly (ventilation device)
8 Interior assembly (sound generating device)
9 Interior assembly (light generating device)
A Airflow
B1-B8 Movement path
C Anchor points
C1, C1′ Anchor points
C2, C2′ Anchor points
K Sound field
L Light

1. An interior adjustment system for a vehicle, comprising
a first interior assembly which has a first adjustment device for adjusting the first interior assembly,
at least one second interior assembly which has a second adjustment device for adjusting the at least one second interior assembly and
a controller,
wherein the controller is designed to activate the second adjustment device in order to adjust the at least one second interior assembly as a function of an adjustment movement of the first interior assembly.

2. The interior adjustment system as claimed in claim 1, wherein the first interior assembly is a vehicle seat or an assembly of a vehicle seat.

3. The interior adjustment system as claimed in claim 2, wherein the first adjustment device is configured by a seat longitudinal adjustment device, a seat height adjustment device or a backrest inclination adjustment device.

4. The interior adjustment system as claimed in claim 1, wherein the at least one second interior assembly is a console element, an armrest, a holding device for holding a functional assembly, a ventilation device, a sound generating device, a light generating device, a display, an operating element or a storage device.

5. The interior adjustment system as claimed in claim 1, wherein the first adjustment device has an electric motor for adjusting the first interior assembly by electric motor.

6. The interior adjustment system as claimed in claim 1, wherein the second adjustment device has an electric motor for adjusting the second interior assembly by electric motor.

7. The interior adjustment system as claimed in claim 1, wherein the first interior assembly can be moved by actuating the first adjustment device from a current first position into an adjusted second position, wherein the controller is designed to activate the second adjustment device in order to adjust the at least one second interior assembly from a current first functional position into an adjusted second functional position as a function of the second position of the first interior assembly.

8. The interior adjustment system as claimed in claim 7, wherein the controller is designed to monitor an adjustment criterion and to activate the second adjustment device in order to adjust at least one second interior assembly from the current first functional position into the adjusted second functional position, as a function of the monitoring of the adjustment criterion.

9. The interior adjustment system as claimed in claim 8, wherein the controller is designed to evaluate as an adjustment criterion an operating event, a use state of the at least one second interior assembly, a collision state of the at least one second interior assembly, a driving state of the vehicle or an occupancy state of one or more vehicle seats.

10. The interior adjustment system as claimed in claim 8, wherein the controller is designed to determine the second functional position as a function of the adjustment criterion.

11. The interior adjustment system as claimed in claim 1, wherein the first interior assembly is adjustable along a first movement path in a vehicle interior.

12. The interior adjustment system as claimed in claim 11, wherein the first interior assembly is able to be moved into a plurality of different positions along the first movement path.

13. The interior adjustment system as claimed in claim 11, wherein the at least one second interior assembly is adjustable along a second movement path in the vehicle interior.

14. The interior adjustment system as claimed in claim 13, wherein the at least one second interior assembly is able to be moved into a plurality of different positions along the second movement path.

15. The interior adjustment system as claimed in claim 13, wherein the controller is designed to activate the second adjustment device in order to adjust the at least one second interior assembly into a position along the second movement path as a function of the position of the first interior assembly.

16. The interior adjustment system as claimed in claim 1, further comprising a sensor device for detecting a position of the first interior assembly and/or the at least one second interior assembly, wherein the controller is designed to evaluate a sensor signal of the sensor device for controlling the second adjustment device.

17. The interior adjustment system as claimed in claim 16, wherein the sensor device is an interior monitoring system.

18. A method for adjusting interior assemblies in an interior of a vehicle, comprising:
adjusting a first interior assembly by using a first adjustment device,
adjusting at least one second interior assembly by using a second adjustment device, and
controlling the second adjustment device in order to adjust the at least one second interior assembly as a function of an adjustment movement of the first interior assembly.
